(19) United States
(12) Patent Application Publication
(10) Pub. No.: US 2026/0307667 A1
(43) Pub. Date: Oct. 8, 2026

(54) METHOD FOR OPERATING AN ENVIRONMENT SENSOR, AND ENVIRONMENT SENSOR

(71) Applicant: Robert Bosch GmbH, Stuttgart (DE)

(72) Inventor: Andreas Heyl, Weil Der Stadt (DE)

(21) Appl. No.: 19/545,116

(22) Filed: Feb. 20, 2026

(30) Foreign Application Priority Data
Mar. 5, 2025 (DE) 10 2025 108 304.5

(51) Int. Cl. B60W 50/02; B60W 50/00; B60W 50/029

(52) U.S. Cl. CPC B60W 50/0205; B60W 50/0097; B60W 50/029; B60W 2050/0031; B60W 2050/0083; B60W 2050/0215; B60W 2555/20

(57) ABSTRACT

A method for operating an environment sensor for a perception system for perceiving a vehicle environment of a vehicle. The method includes: providing the environment sensor for detecting at least one environment region of the vehicle environment; proceeding from the perception system and by means of the environment sensor, receiving at least one condition parameter elating to an environment condition; independently calculating, by means of the environment sensor, at least one capability parameter relating to a capability of the environment sensor at least depending on the condition parameter; outputting the capability parameter to the perception system. An environment sensor is also described.

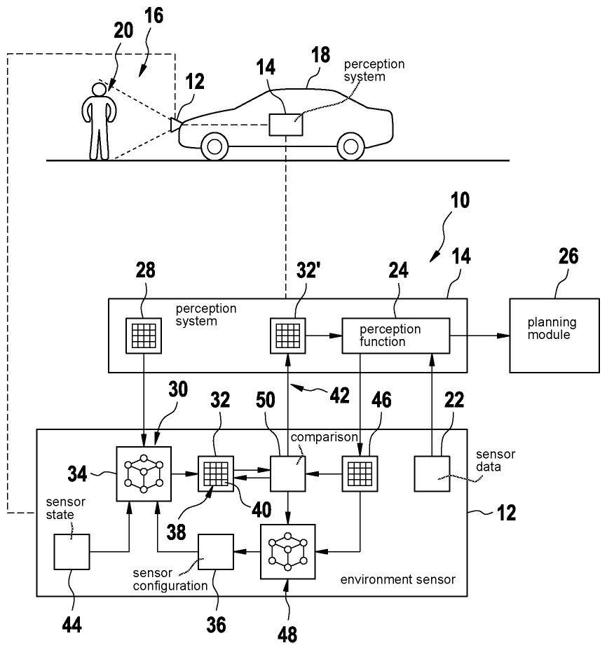

### FIELD

The present disclosure relates to a method for operating an environment sensor. The present disclosure also relates to an environment sensor.

### BACKGROUND INFORMATION

Vehicle environment perception systems often integrate various sensor modalities that utilize different physical principles, in order to build a reliable data basis for environment perception. The sensor data provided by the plurality of environment sensors are then combined in a sensor data fusion to create a consistent environment model. This environment model includes, inter alia, the position and movement of objects in the vehicle environment. In this case, the quality of the environment model influences the performance of the driving functions, in particular in fully autonomous systems, where driving decisions are made on this basis and the vehicle's actuators, for example for steering, acceleration and braking, are controlled.

The quality of the environment model depends, in turn, on sensor errors that can arise from physical limitations or external disturbances. These include incorrect measurements, false positives (FP) and false negatives (FN), which can lead to an incorrect detection of the environment and an unreliable perception of the environment. The draft standard ISO 21448 (SOTIF) addresses measures for identifying and reducing such uncertainties in the development process, in order to avoid safety-critical effects. As is conventional, the capabilities of the individual environment sensors are taken into account as early as during the development process.

### SUMMARY

According to the present disclosure, a method for operating an environment sensor is provided. According to an example embodiment, the method includes: providing the environment sensor for detecting at least one environment region of the vehicle environment; proceeding from the perception system and by means of the environment sensor, receiving at least one condition parameter relating to an environment condition; independently calculating, by means of the environment sensor, at least one capability parameter relating to a capability of the environment sensor at least depending on the condition parameter; and outputting the capability parameter to the perception system.

This allows the vehicle's perception system to learn about and take into account the capabilities of the environment sensor during operation. The perception system can be designed and expanded more flexibly. For example, another such environment sensor can be integrated into the perception system more easily and with less effort. The sensor-internal calculations of the capabilities do not need to be fully disclosed. Furthermore, the calculation of the capability parameter can be outsourced to the environment sensor.

The vehicle can be a motor vehicle, a two-wheeled vehicle, an electric vehicle, a mobile device or a robot. The vehicle can control a driver assistance function, a semi-autonomous and/or autonomous driving function, depending on the method for operating the environment sensor.

The environment region can be a spatial sub-region of the vehicle environment or the entire vehicle environment. The environment region of the vehicle environment can be the spatial region around the vehicle that is detected by the environment sensor. The environment region may vary depending on the sensor range of the environment sensor, visibility conditions, and/or the driving speed.

The perception system can be a system that processes sensor data from a plurality of such environment sensors, in particular including algorithms, object recognition, sensor data fusion and/or data processing units, which, for example, provides the environment information for the vehicle's driving functions. The perception system can receive and process capability parameters of a plurality of such environment sensors. The perception system can apply at least one artificial intelligence model. The perception system can process information by applying at least one rule and/or one model. The perception system can receive information from information sources external to the vehicle, for example via V2X.

The perception system can create at least one environment model of the vehicle environment. The environment model can be entered into a planning module, in particular for driving strategy planning.

The perception system can perform at least one perception function. The perception function can process sensor data from the environment sensor, in particular for minimizing misinterpretations of the vehicle environment. The perception function can perform sensor data fusion of sensor data from a plurality of such environment sensors. The result of the calculation with the perception function can be output to the planning module, in particular for the driving strategy planning of the vehicle. The capability parameter can form an input for processing in the perception function. The perception function can be, for example, object classification.

The environment sensor can be a radar sensor, a LIDAR sensor, a camera or an ultrasonic sensor. The environment sensor can detect sensor data, in particular measured values, and make them available for processing by the perception system.

The environment condition can refer to the vehicle environment. The environment condition of the perception system can be an external influencing variable that can in particular change the perception capability of the perception system. The environment condition can influence the capability of the perception system to perform the environment perception correctly and reliably. The external influencing variable can specify weather conditions, visibility conditions, obstructions, interfering reflections and/or sources of interference. The environment condition can be a detection condition of the perception system. The environment condition can be situation-dependent. The environment condition can be derived from the internal sensor data and/or from external data sources, such as V2X or map data. The environment condition can be global, for example weather conditions, spatial, for example a road surface condition, relatively local, for example an obstruction, and/or dynamic, for example a traffic volume.

The condition parameter can comprise a plurality of condition values assigned to spatial sub-regions of the vehicle environment. The condition parameter can have a specific data format. The data format can be a raster-based grid model. The data format can be a raster-based grid model. The grid model can be two-dimensional or three-dimensional. The data format can enable spatial assignment and evaluation of the condition values. The grid model can divide the vehicle environment into a plurality of spatial grid cells. The condition values can be assigned to the grid cells. The condition values can be numerical values, categories and/or confidence values. The condition values can spatially resolve the environment condition.

The capability can, in each case with regard to the environment sensor, be a performance, limitation and/or restriction of the environment detection. The capability can be function-specific, i.e., related to a function, in particular a detection function of the environment sensor. The capability may be limited to detecting a sub-region of the vehicle environment. The capability can be the suitability of the environment sensor to perform a specific task in a predefined spatial sub-region of the vehicle environment at a predefined time, given the condition parameter. The capability can indicate a risk of unexpected system behavior despite a technically flawless environment sensor, for example due to misinterpretation and/or adverse weather conditions.

The capability parameter can specify the capability depending on location and/or time. The capability parameter can provide a structured representation of the environment sensor's capability, in particular to reliably perform a defined task. The capability parameter can be a quantitative or qualitative metric that preferably describes how well an environment sensor can perform a specific perception task under defined conditions. The capability parameter can be a characteristic value that describes, for example, the accuracy of object detection, the detection range, or the uncertainty of the sensor data. The capability parameter can be calculated through a capability assessment in the environment sensor.

The independent calculation of the capability parameter by the environment sensor can be a calculation internal to the sensor, i.e., performed within the environment sensor, or a calculation external to the sensor, i.e., initiated by the environment sensor and outsourced, in particular performed in a cloud. The calculation of the capability parameter can have variable accuracy, for example depending on the utilization of the environment sensor.

The sensor configuration can be specified by at least one configuration value. The sensor configuration can specify, with respect to the environment sensor, at least one fault state, in particular a sensor function, one environment condition, in particular a temperature, one environmental influence, in particular an obstruction, one system state, in particular a utilization, one operating mode, in particular in normal operation, one sensor position on the vehicle, one sensor pose and/or one coverage region of the vehicle environment.

In a preferred example embodiment of the present disclosure, it is advantageous if the capability parameter is calculated depending on a sensor configuration of the environment sensor. The sensor configuration can specify at least one operating parameter of the environment sensor. The operating parameter can be a resolution, a detection region, a range, a refresh rate, a computational load, an inclusion of information, and/or signal processing.

The capability parameter can be calculated depending on the sensor state of the environment sensor. The sensor state can be an operating state, for example a normal state or a fault state, of the environment sensor.

The sensor configuration can be adaptively adjustable. The sensor configuration can be adjusted via the environment sensor.

A preferred example embodiment of the present disclosure is advantageous in which the environment sensor independently adjusts the sensor configuration depending on at least one default capability parameter. The default capability parameter can be provided by the perception system. The default capability parameter can be calculated and provided by the perception system depending on a planned driving behavior of the vehicle. The default capability parameter can be received by the environment sensor. The default capability parameter can be a specification for at least one predefined capability, in particular analogous to the capability of the capability parameter. The default capability parameter can specify a required capability. The default capability parameter can be a target parameter and/or a limit parameter of the capability parameter.

The environment sensor can optimize the sensor configuration depending on the at least one default capability parameter for improving the capability of the environment sensor. The capability parameter can be calculated depending on the optimized adjusted sensor configuration.

In an advantageous example embodiment of the present disclosure, it is provided that the capability parameter and the default capability parameter have the same data format. In this way, a comparison between the capability parameter and the default capability parameter can be performed more easily and more accurately. The capability parameter can have a plurality of capability values.

The data format can be a structured, grid-based representation that specifies the values in spatial regions and at specific times. The data format can specify the values in a grid, with values assigned to each grid cell.

In a preferred example embodiment of the present disclosure, it is provided that the capability parameter is compared with the default capability parameter, by way of a comparison, and the capability parameter is output depending on the comparison. The capability parameter can be output if the specifications given by the default capability parameter are met.

In a specific example embodiment of the present disclosure, it is advantageous that if the capability parameter does not meet the specifications given by the default capability parameter, the sensor configuration is adjusted. The sensor configuration can be set by repeating the adjustment of the sensor configuration depending on the comparison and the default capability parameter. The capability parameter can be changed again by the changed sensor configuration, depending on the comparison, and compared with the default capability parameter.

A preferred example embodiment of the present disclosure is advantageous in which the capability parameter is calculated for a current and/or future perception time of the perception of the perception system. The perception time can be the specific point in time at which the perception system detects, processes, and evaluates the vehicle environment.

In a preferred example embodiment of the present disclosure, it is advantageous if the capability parameter comprises a plurality of capability values assigned to spatial sub-regions of the vehicle environment. The capability value can specify the capability in terms of value. The capability value can have a specific data format. The data format can be a raster-based grid model. The grid model can be two-dimensional or three-dimensional. The data format can enable spatial assignment and evaluation of the capability values. The grid model can divide the vehicle environment into a plurality of spatial grid cells. The capability values can be assigned to the grid cells. The capability values can be numerical values, categories and/or confidence values.

A preferred example embodiment of the present disclosure is advantageous in which the capability parameter is calculated by a capability assessment model in the environment sensor, at least depending on the condition parameter. The capability assessment model can perform the capability assessment for calculating the capability parameter. The capability assessment model can perform a rule-based calculation and/or a calculation by applying an artificial intelligence model.

The method for operating the environment sensor can be subordinate to a method for operating the perception system. The method for operating the perception system can have all the features of the method for operating the environment sensor. Furthermore, the method for operating the perception system may include providing the perception system and perceiving the vehicle environment depending on the capability parameter output by the environment sensor. The capability parameter can be used by the perception system to meet SOTIF safety requirements.

The method for operation can be a computer-implemented method.

Furthermore, a computer program that comprises machine-readable instructions executable on at least one computer, upon execution of which the above-described method runs, is provided.

Furthermore, a storage unit is provided, which is designed to be machine-readable and accessible by at least one computer and on which the aforementioned computer program is stored. The storage unit can be arranged in the vehicle.

According to the present disclosure, an environment sensor is also provided.

Further advantages and advantageous configurations of the present disclosure can be found in the description of the figure and in the figure.

### BRIEF DESCRIPTION OF THE DRAWING

The figure shows an example embodiment of a method for operating an environment sensor according to the present disclosure.

### DETAILED DESCRIPTION OF EXAMPLE EMBODIMENTS

The present disclosure is described in detail below with reference to the figure. The figure shows a method for operating an environment sensor, in a specific embodiment of the present disclosure. The method for operating 10 an environment sensor 12 for a perception system 14 for perceiving a vehicle environment 16 of a vehicle 18 comprises providing the environment sensor 12 for detecting at least one environment region 20 of the vehicle environment 16. The environment sensor 12 can be a camera, a radar sensor, a LIDAR sensor or an ultrasonic sensor. The perception system 14 can process the sensor data 22 of the environment sensor 12 and preferably of other such environment sensors of the vehicle 18, for perceiving the vehicle environment 16.

The perception system 14 performs at least one perception function 24. The perception function 24 can process the sensor data 22 of the environment sensor 12, in particular for minimizing misinterpretations of the vehicle environment 16. The perception function 24 can perform a sensor data fusion of sensor data 22 from a plurality of such environment sensors 12. The result of the calculation with the perception function 24 can be output to a planning module 26, in particular for the driving strategy planning of the vehicle 18.

The environment sensor 12 receives from the perception system 14 at least one condition parameter 28 regarding an environment condition. The environment condition can be an external influencing variable that can change the perception capability of the perception system 14. The external influencing variable can specify weather conditions, visibility conditions, obstructions, interfering reflections and/or sources of interference. The environment condition can be ascertained by prior perception of the vehicle environment 16 and/or by external information, such as weather information.

Furthermore, a calculation 30 of at least one capability parameter 32 with respect to a capability of the environment sensor 12 is performed by the environment sensor 12 with a capability assessment model 34, at least depending on the condition parameter 28. The capability, in each case with regard to the environment sensor 12, is a performance, limitation and/or restriction of the environment detection. The capability parameter 32 is a structured representation of the capability of the environment sensor 12, and is calculated depending on a sensor configuration 36 of the environment sensor 12. The sensor configuration 36 can specify operating parameters, such as a resolution, of the environment sensor 12.

The capability parameter 32 has a specific data format 38. The data format 38 can be a raster-based grid model. The grid model can be two-dimensional or three-dimensional. The grid model can divide the vehicle environment 16 into a plurality of spatial grid cells. The capability parameter 32 has in particular a plurality of capability values 40 which are assigned to spatial sub-regions of the vehicle environment 16 and which are assigned to the grid cells. The capability values 40 can be numerical values, categories and/or confidence values.

The calculation 30 of the capability parameter 32 can be performed for a current and/or future perception time of the perception of the perception system 14. The capability parameter 32 is then transmitted by an output 42 to the perception system 14, which processes the capability parameter 32 as an input of the perception function 24.

The capability parameter 32 is further calculated by the capability assessment model 34 depending on a sensor state 44, for example an operating state, of the environment sensor 12.

The perception system 14, in particular the perception function 24, transmits a default capability parameter 46 to the environment sensor 12, which parameter is a specification for at least one predefined capability, in particular analogous to the capability of the capability parameter 32. The environment sensor 12 independently adjusts the sensor configuration 36, depending on the default capability parameter 46, with a configuration adjustment 48. The adjusted sensor configuration 36 can in turn be used to calculate 30 the capability parameter 32.

The capability parameter 32 and the default capability parameter 46 preferably have the same data format 38.

By means of a comparison 50, the capability parameter 32, calculated with the capability assessment model 34 depending on the sensor state 44 and the adjusted, i.e., optimized, sensor configuration 36, is compared with the default capability parameter 46, and the possibly changed capability parameter 32′ is output depending on the comparison 50. In this case, the capability parameter 32 is output as a capability parameter 32′ in particular if the capability parameter 32 meets the specifications given by the default capability parameter 46 when checked by the comparison 50. If the capability parameter 32 does not meet the specifications given by the default capability parameter 46, the sensor configuration 36 can be adjusted again depending on the comparison 50 and the default capability parameter 46, with the configuration adjustment 48, and the capability parameter 32 can be changed depending on the optimized sensor configuration 36 and output as a changed capability parameter 32′ if the specifications are met when checked by the comparison 50. This process can be repeated several times if necessary.

The configuration adjustment 48 can be rule-based, model-based and/or by applying an artificial intelligence model. The configuration adjustment 48 can, for example, adjust the sensor configuration 36 in such a way that a selected environment region of the vehicle environment 16 is detected more accurately.

For example, the default capability parameter 46 can be ascertained by the perception system 14 using map information. The default capability parameter 46 can for example specify in the grid model of the vehicle environment 16 that the reliable detection of a traffic light and its signal in a particular environment region relative to the vehicle 18, in particular within selected three-dimensional grid cells of the vehicle environment 16, at a current or imminent perception time, is critical for driving safety. By calculating 30 the capability parameter 32 depending on the default capability parameter 46, the perception system 14 can ensure that, under the environment conditions specified by the condition parameter 28, the environment sensor 12 has a capability that complies with the default capability parameter 46 and is specified by the capability parameter 32, in particular for reliably detecting the traffic lights. For example, if the environment sensor 12 is a camera, then the environment sensor 12 must not be blinded by sunlight or reflections, and obstacles must not obstruct the view. The capability parameter 32 should be such that uncertainties of the environment sensor 12 are not critical in order to enable a reliable perception of the vehicle environment 16.

1-10. (canceled)

11. A method for operating an environment sensor for a perception system for perceiving a vehicle environment of a vehicle, comprising the following steps:
providing the environment sensor for detecting at least one environment region of the vehicle environment;
proceeding from the perception system and using the environment sensor, receiving a condition parameter relating to an environment condition;
independently calculating, using the environment sensor, a capability parameter relating to a capability of the environment sensor at least depending on the condition parameter; and
outputting the capability parameter to the perception system.

12. The method for operating according to claim 11, wherein the capability parameter is calculated depending on a sensor configuration of the environment sensor.

13. The method for operating according to claim 12, wherein the environment sensor independently adjusts the sensor configuration depending on a default capability parameter.

14. The method for operating according to claim 13, wherein the capability parameter and the default capability parameter have the same data format.

15. The method for operating according to claim 13, wherein the capability parameter is compared with the default capability parameter using a comparison, and the capability parameter is output depending on the comparison.

16. The method for operating according to claim 15, wherein, when the capability parameter does not meet specifications given by the default capability parameter, the sensor configuration is adjusted.

17. The method for operating according to claim 11, wherein the calculation of the capability parameter is carried out for a current and/or future perception time of a perception of the perception system.

18. The method for operating according to claim 11, wherein the capability parameter includes a plurality of capability values assigned to spatial sub-regions of the vehicle environment.

19. The method for operating according to claim 11, wherein the capability parameter is calculated by a capability assessment model in the environment sensor, at least depending on the condition parameter.

20. An environment sensor for a perception system for perceiving a vehicle environment of a vehicle configured to detect at least one environment region of the vehicle environment of the vehicle and configured to be operated by performing the following steps:
proceeding from the perception system and using the environment sensor, receiving a condition parameter relating to an environment condition;
independently calculating, using the environment sensor, a capability parameter relating to a capability of the environment sensor at least depending on the condition parameter; and
outputting the capability parameter to the perception system.
